(19) United States
(12) Patent Application Publication
(10) Pub. No.: US 2026/0035023 A1
(43) Pub. Date: Feb. 5, 2026

(54) METHOD, RAILWAY SYSTEM AND COMPUTER PROGRAM PRODUCT FOR MONITORING A SECTION OF TRACK

(71) Applicant: Siemens Mobility GmbH, München (DE)

(72) Inventor: Jens Braband, Braunschweig (DE)

(21) Appl. No.: 19/288,055

(22) Filed: Aug. 1, 2025

(30) Foreign Application Priority Data
Aug. 1, 2024 (EP) 24192327.5

(51) Int. Cl. B61L 23/04; G06T 7/70; G06V 20/52; G06V 20/58

(52) U.S. Cl. CPC B61L 23/041; G06T 7/70; G06V 20/52; G06V 20/58; G06T 2207/30232; G06T 2207/30261

(57) ABSTRACT

A method monitors a section of track for obstacles. The section of track is monitored by a first sensor and a second sensor. The first sensor operates on a vehicle, and the second sensor operates in a fixed position on the section of track. During operation, the sensors are aligned with the track such that each location of the section of track is present in a first image of the first sensor and a second image of the second sensor. The first images and the second images are analyzed for obstacles in the section of track. A signal indicating the presence of an obstacle is generated if an obstacle is detected in both the first images and also in the second images. A first signal indicating an error is generated if the obstacle was detected only in the first images or only in the second images.

### CROSS-REFERENCE TO RELATED APPLICATION

This application claims the priority, under 35 U.S.C. § 119, of European Patent Application EP 24192327.5, filed Aug. 1, 2024; the prior application is herewith incorporated by reference in its entirety.

### FIELD AND BACKGROUND OF THE INVENTION

The invention relates to a method for monitoring a section of track. Furthermore, the invention includes a railway system with a platform and a section of track located thereon. Furthermore, the invention relates to a computer program product containing program commands. Furthermore, the invention relates to a computer-readable storage medium containing data.

### TECHNICAL BACKGROUND

According to the prior art, monitoring of platforms by means of cameras on the platforms or on the train is known. The camera images are monitored, for example, by the operating personnel of a rail operator so that rail traffic can be interrupted if an obstacle is discovered on the section of track which extends along the platform. Obstacles are understood to be objects or living creatures the size of which would lead to a collision with an incoming train. These are foreign objects on the relevant section of track, which can preferably reach the section of track starting from the platform. A similar situation also arises in the danger zones of level crossings.

The problem which arises from the prior art described above is that manual monitoring of sections of track, in particular at platforms and level crossings, is labor-intensive and therefore costly. In addition, misjudgments on the part of personnel cannot be ruled out. However, the automation of monitoring poses the problem that the task to be tackled is a safety-related issue (safety is to be understood in the sense of operational safety in the context of this description of the invention), so that automation must meet the safety requirements in rail operation.

In order to increase the reliability of obstacle detection in rail traffic, various approaches were pursued in the past. According to European patent applications EP 4124542 A1 and EP 4299411 A1 (corresponding to U.S. patent publication No. 2024/0001976) for example markers are used for this purpose, which carry information in the form of coding for detection as objects. These are intended to make obstacle detection, for example at a level crossing, safer because the detection of all the markers is considered as proof that there is no obstacle obscuring the markers. European patent application EP 4389558 A1 also proposes that obstacle detection can be tested during the operation of a rail-borne vehicle in order to increase the reliability of obstacle detection.

### SUMMARY OF THE INVENTION

The object of the invention is to remedy the problems described in the prior art. In particular, it is the object of the invention to specify a method for monitoring a section of track with which monitoring can be automated and at the same time a high level of safety can be achieved. Furthermore, it is the object of the invention to specify a vehicle, a computer program product and a computer-readable storage medium with which the improved method can be carried out.

According to a first aspect of the invention, a method for monitoring a section of track is described in which the section of track is recorded by at least one first imaging sensor and at least one second imaging sensor for the purpose of monitoring.

Imaging sensors are sensors where the measured values of which can be converted into an image of the environment to be monitored, i.e. primarily the section of track and the platform edge. These can be, for example, optical cameras, radars, lidar and the like.

If a section of track is referred to in the context of this description of the invention, this refers to the track system, containing a superstructure, consisting mainly of the rails and the sleepers (in addition, for example, fastening means for the rails) and a substructure which provides the substrate for the sleepers, for example a fill or a concrete base. It is readily apparent that the aforementioned components of the section of track form part of the visible surface and are therefore represented in the imaging method. However, if these components are obscured by an object, this can be determined in a known manner by evaluating the images generated by the imaging method. Here, for example, the method can make use of computer-generated artificial intelligence.

An apparatus is computer-aided or computer-implemented if it has a computing environment, or a method is computer-aided or computer-implemented if a computing environment executes at least one method step of the method.

A computing environment is an IT infrastructure, consisting of functional components such as processors, storage units, programs and data to be processed with the programs, which is used for the execution of at least one application which has an object to achieve. Other functional components can consist of sensors and actuators which enable the interaction of the computing environment with the outside world. The IT infrastructure can also be organized as a network of the aforementioned functional components.

Within a computing environment, computing instances form functional units which can be assigned to applications (given, for example, by a number of program modules) and can execute these applications. These functional units form physically (for example, computer, processor) and/or virtually (for example, program module) self-contained systems when executing the application.

Computers are electronic devices consisting of a plurality of functional components with data processing properties. Computers can be, for example, clients, servers, handheld computers, communication devices and other electronic devices for data processing which may have processors and storage units and can also be combined to form a network via interfaces.

Processors can be, for example, converters, sensors for generating measurement signals or electronic circuits. A processor can be a central processing unit (CPU), a microprocessor, a microcontroller, or a digital signal processor, possibly in combination with a storage unit for storing program commands and data. A processor can also be a virtualized processor or a soft CPU.

Storage units can be implemented on computer-readable memories in the form of random access memory (RAM) or data storage devices (hard disk or data carrier).

Program modules are individual software functional units which enable a program sequence according to the invention of method steps. These software functional units can be realized in a single computer program or in a plurality of computer programs communicating with one another. The interfaces realized here can be implemented in terms of software within a single processor or in terms of hardware if a plurality of processors is used.

Interfaces can be realized using hardware, for example wired or as a radio link, or using software, for example as an interaction between individual program modules of one or more computer programs, and are used to exchange data, preferably in the form of digital data sets or analog signals.

In order to avoid any misunderstanding, it should be noted that individual claim features are numbered consecutively with lower case Latin letters, without taking the claim numbering into account. This means that each letter only appears once in the entire set of claims, which makes it possible to clearly address the relevant claim features without mentioning the claim number. For this reason, however, the sequence of letters has no significance.

According to the invention, it is provided that:
the at least one first sensor is operated on a vehicle, and the at least one second sensor is operated in a fixed position on the section of track, the sensors being aligned with the section of track during operation in such a manner that each location of the section of track is present in a first image of the at least one first sensor and in a second image of the at least one second sensor,
the first images and second images are analyzed with the aid of a computer for obstacles in the section of track, a signal indicating the presence of an obstacle is generated if an obstacle has been detected by means of analysis both in the at least one of the first images and also in the at least one of the second images, and
a signal indicating an error is generated if the obstacle has been detected by means of analysis only in the at least one of the first images or only in the at least one of the second images.

The terms used in this description of the invention have the following meaning.

If this description of the invention refers to a first sensor and a second sensor, the first sensor should be linked to the vehicle and should therefore be operated on this vehicle and the second sensor should be linked to the section of track and should therefore be in a fixed position so that it can be operated permanently on the relevant section of track. In contrast, the first sensor on the vehicle can only be operated on the relevant section of track when this section of track is passed by the vehicle. If a plurality of sensors are used on the vehicle for the purpose according to the invention, all of these sensors are first sensors. If a plurality of second sensors are used in a fixed position on the section of track for the purpose according to the invention, they are all second sensors.

If detection by means of the generation of images is referred to in the context of this description of the invention, this means that the imaging sensor scans the section of track or measures existing radiation emanating from the section of track. This can be done optically by an image sensor, for example, but also by scanning using radar, for example, it also being possible for an image to be generated with the aid of radar scanning.

If the images overlap, this means that the overlapping area, which can preferably make up 100% of the two images under consideration, was recorded by both a first sensor and a second sensor. In other words, the image was recorded redundantly by two imaging systems, namely the track-side imaging system in a fixed position and the on-board, mobile imaging system. Advantageously, this creates redundancy, which can be used for failure disclosure of the two systems (more on this hereinafter). In this way, the two systems support each other in the continuous checking of their functional safety.

Within the meaning of the invention, obstacles are all objects the presence of which is detected in the section of track without these bodies being intended or permitted to be there. Examples include people, animals or larger inanimate objects. Inanimate objects also include plants or parts of plants as these cannot move independently. Objects which are part of the railway system in the broader sense and cover the section of track, such as balise housings, for example, do not count as obstacles.

On account of its characteristics, a signal indicating an obstacle is to be interpreted as meaning that a foreign object has been detected in the section of track. This is also referred to in short hereinafter as an obstacle signal. On account of its characteristics, a signal indicating an error is to be interpreted as meaning that an error is present which means that a foreign object has only been detected once. An error must be present because the overlap of the generated images is sufficient for each location of the section of track to be present in at least two images. However, this also means that a detected foreign object influences the creation of at least two images. If a foreign object has therefore only been detected once, there is an error with regard to the proper course of the method which may have different causes. The causes include:

A foreign object could be placed at the edge of the image in such a way that it is not fully shown and therefore not recognized.

Image recognition in an image may not have been successful, even though the foreign object is placed entirely in the image.

An imaging sensor could be defective, for example it could have failed completely.

This means that the error signal can be interpreted in a plurality of ways and necessitate different measures. The hardware and software involved in the method can be checked for proper function (maintenance can be requested, for example). In addition, the presence of an obstacle is likely, for which reason the obstacle signal is also generated in this case according to the method step c). In other words, the fact that an error signal is generated in the method step d) is not interpreted to mean that an obstacle signal generated according to method step c) was wrongly generated, even if this cannot be ruled out. In the interest of operational safety, in case of doubt action is taken as if the obstacle signal was generated correctly.

One advantage of the invention is that as a result of the redundant generation of obstacle signals, an additional failure disclosure for the hardware and software involved in the method is firmly implemented in the method sequence. In other words, during a proper course of the method, an obstacle signal for the foreign object concerned must always be generated twice, i.e. generated redundantly. If this is not the case, this indicates one of the aforementioned errors 1) to 3). A partial failure of the system therefore means that it can still be used to detect foreign objects in the section of track. This is achieved by the fact that even the one-off detection of a foreign object as an obstacle, as explained above, is taken as an opportunity to generate an obstacle signal. At the same time, however, the method can be repaired in good time so that a complete failure does not normally occur. For example, a defective camera can be replaced. This increases the operational safety of the method so that it can also be used advantageously in safety-related applications such as the monitoring of a section of track adjacent to a platform in the present case. Ideally, the SIL-1 and SIL-2 safety levels applicable to such a task in rail operation can be achieved.

The requirements for the certification of safety-related applications, for example in rail technology, are very demanding. According to the international standard IEC 61508 or specifically for the rail sector according to the European standard EN 50129, four safety integrity levels (SIL) or safety requirement levels for the required functional safety are distinguished for safety functions. Safety integrity level 4 represents the highest level of safety integrity and safety integrity level 1 the lowest level. The respective safety integrity level influences the confidence interval of a measured value to the effect that the higher the safety integrity level to be met by the respective apparatus, the lower the confidence interval. The dimension of functional safety of the various safety integrity levels can be clearly described with the expected frequency of a failure of the safety-related system MTBF (Mean Time Between Failures), this being specified in years (a). For SIL-1, this is in the range of 10 . . . 100 a, for SIL-2 this is in the range of 100 . . . 1000 a, for SIL-3 this is in the range of 1000 . . . 10000 a, and for SIL-4 this is in the range of 10000 . . . 100000 a.

According to a further aspect of the invention, a railway system with a section of track is described, a multiplicity of imaging sensors for monitoring the section of track being installed in the railway system. In particular, the railway system can have a level crossing or a platform which are arranged in the immediate vicinity of the relevant section of track.

According to this aspect, it is provided according to the invention that the railway system has a computing environment which is set up to perform a method as claimed in one of the preceding claims. The advantages associated with this aspect of the invention have already been explained above, with reference being made to these advantages.

A computer program product containing program commands which can be executed by a computing environment is described according to a further aspect of the invention. According to this aspect, it is provided according to the invention that at least the steps b), c) and d) of the method described above are carried out.

According to the invention, a computer program product containing program modules with program commands is thus described, the program modules being able to run in the same computing instance or a plurality of computing instances of the computing environment. By means of the computer program product, which may comprise one computer program or a plurality of computer programs, the method according to the invention and/or its exemplary embodiments can be executed and the advantages described above are achieved with the embodiment.

According to another aspect of the invention, a computer-readable storage medium containing data which is stored as data sets by the storage medium is described. According to this aspect, it is provided according to the invention that the data sets make the computer program product described above executable as claimed in the last preceding claim.

Furthermore, a provision apparatus for storing and/or providing the computer program in the form of a computer-readable storage medium is thus described. The provision apparatus is, for example, a storage unit which stores the computer program and makes it available for retrieval. Alternatively or in addition, the provision apparatus is a network service, a computer system, a server system, in particular a distributed, for example cloud-based computer system or virtual computer system, which stores the computer program on a computer-readable storage medium and preferably provides it in the form of a data stream.

Provision takes place in the form of program data sets describing program modules as a file, in particular as a download file, or as a data stream, in particular as a download data stream, of the computer program product. The computer program product is transferred to a computing environment, for example using the provision apparatus, so that the method according to the invention can be executed in a computing instance or a plurality of computing instances of this computing environment.

### Embodiments of the Invention

Variants describing developments of the invention are described hereinafter without limiting the fundamental idea of the invention.

According to one variant, the aspects of the invention explained above are determined by the fact that each of the second sensors belongs to a second group of second sensors arranged at a distance from one another on the section of track, the generated images of the second group in each case adjoining adjacent images in a border area, that is to say that the distance between the second sensors is selected in such a manner that an overlap or seamless adjacency of the individual images is realized, taking into account the image sections which can be mapped by the sensors.

When in the context of this description of the invention reference is made to images being adjacent to one another, this means that the contents of the images which are adjacent to one another fit together in such a manner that a complete overall image is created. The focus of this overall image is the section of track to be monitored, which is thus represented completely and seamlessly in each group of images. The border area of the images therefore lies at the respective edge of these images. The border area of the images is, in other words, a connecting area between adjacent images by means of which the contents of the images can be joined together seamlessly. Computer-aided algorithms which enable such a supplementation of the individual images to form an overall image are generally known and therefore do not need to be explained in more detail at this point.

The border area can therefore be defined as the edge area of the adjacent images where they border on the respective adjacent image. For practical reasons (alignment of the cameras in the stations), an overlapping area may also occur in the border area. Essentially, however, this embodiment of the invention is designed not to use such an overlapping area to generate redundant pixels in the overall image of a group of images (i.e. the images generated by one group of sensors). Instead, the first sensor or a group of several first sensors on the vehicle is used to generate the redundancy. It should be noted here that if the vehicle is moving, a complete image of the section of track can also be generated with just one first sensor as the imaging first sensor can move along the section of track with the vehicle. However, a plurality of first sensors can also be used on the vehicle, forming a first group of sensors.

As a result of there also being two groups of images matching the first and second sensors, each of which in itself contains a complete recording of the section of track, the redundancy of the mapping of individual image elements already explained above, namely once in the first group and once in the second group, is ensured. Of course, this does not exclude the possibility that a third group or other groups of images can also be generated, so that a triple or even multiple redundancy is generated.

One advantage of this variant is that by assigning the sensors to the first group (or using a single first sensor) and to the second group, the generation of redundancy in the detection of objects in the images can be well controlled. These objects are then mapped exactly once in each group of images, i.e. exactly twice when using a first group and a second group. This simplifies the method by means of which the need for error signals is determined. In addition, the occurrence of an error can be advantageously determined with a comparatively high degree of certainty.

According to one variant, the aspects of the invention explained above are determined by the fact that the function of monitoring the section of track by the at least one first sensor is checked by:
arranging a first test structure in the section of track as an obstacle, which can be driven over by the vehicle without collision and the position of which in the section of track is available to the method as a position data set,
analyzing the first images for obstacles in the section of track with the aid of a computer, and
outputting a second signal indicating an error if no obstacle is detected by means of analysis at the position identified by the position data set.

A test structure which is safe for the vehicle to drive over requires spatial expansions which do not lead to a collision when the vehicle crosses the test structure. These can be three-dimensional mock-ups of smaller objects, for example. The advantage of a crossing being dangerous is that these test structures can be permanently installed in the track bed so that the function of the on-board system can be checked with a computing environment for obstacle detection including the on-board sensor. This has the advantage of increasing the probability of a failure disclosure, as a result of which the probability of undetected errors jeopardizing the functional reliability of the system is reduced.

As the position of the test structure is known based on the evaluation of the position data set, bearing in mind the position of the vehicle, which is determined in a known manner per se with the usual functional reliability (safety) for rail traffic, it can be predicted where and therefore also when the obstacle designed as a test structure must be detected. If the expected detection does not occur, this therefore indicates an error and the second signal can be generated. In this manner, a failure disclosure is advantageously realized for the method used and the components deployed in the process.

According to one variant, the aspects of the invention explained above are determined in that the signal indicating an obstacle generated according to step c) explained above is characterized as a test signal.

The identification of the signal indicating an obstacle as a test signal advantageously prevents this signal from being interpreted by the computer as a signal indicating an actual obstacle. Alternatively, this can of course also be achieved by initiating a test routine associated with the detection of test structures as such in the method according to the invention and not evaluating the obstacles detected during this time as real obstacles. However, the identification of a corresponding signal as a test signal here creates additional peace of mind with respect to misinterpretations, a test routine in the method not needing to be characterized as such. This advantageously enables real obstacles to be detected even during this period, which then generate signals which are not characterized as test signals.

According to one variant, the aspects of the invention explained above are determined in that the test structure consists of a two-dimensional representation of an obstacle on a screen:
the screen being aligned parallel to or at an angle of no more than 30°, preferably no more than 10° to the substrate of the section of track, and
the obstacle being shown distorted on the screen, the obstacle appearing undistorted in relation to an image axis for the first sensor.

In other words, it can be said that the obstacle which is shown on the screen creates an optical illusion for the imaging sensor. Advantageously, this can also be used to display obstacles which are larger than required for the vehicle to pass without a collision. This also opens up the test procedure according to the invention for these larger obstacles, as a result of which failure disclosure can advantageously be carried out more reliably.

According to one variant, the aspects of the invention explained above are determined in that the function of monitoring the section of track by at least one second sensor is checked when there is a vehicle on the section of track by:
making the current position of the vehicle available in a position data set,
analyzing the second images for obstacles in the section of track with the aid of a computer, and
outputting a third signal which indicates an error if no obstacle is detected at the current position identified by the position data set as a result of the analysis.

One advantage of this variant is that vehicles regularly use the section of track at a platform to enable people to board and alight. A test routine can then always be carried out. The vehicle must be recognized in the process. In this way, the function of the method and the hardware components involved in its execution such as, for example, the sensors can be checked regularly. This advantageously increases safety during the execution of the method, the test routine enabling a failure disclosure for components of the components involved in the execution of the method.

According to one variant, the aspects of the invention explained above are determined in that manual monitoring of the section of track for obstacles by railway personnel is requested as soon as the first signal or the second signal or the third signal has been evaluated.

In this variant of the invention, it is advantageously taken into account that as soon as an error signal has been generated (first signal, second signal or third signal, indicating an error), the operation of safe obstacle detection with the aid of a computer is no longer guaranteed. In this case, it is possible to resort to manual detection of obstacles, for example by the station staff or the train driver. It may also be necessary to reduce the maximum permitted speed in order to ensure reliable manual monitoring of the route. Advantageously, however, train operation does not have to be stopped completely as it is only a matter of oversizing the route for obstacles, while train operation per se can still be carried out reliably.

Other features which are considered as characteristic for the invention are set forth in the appended claims.

Although the invention is illustrated and described herein as embodied in a method for monitoring a section of track, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Further details of the invention are described hereinafter with reference to the diagram. Identical or corresponding drawing elements are each provided with the same reference characters in the individual figures and are only explained more than once to the extent that there are differences between the individual figures.

The exemplary embodiments explained hereinafter are preferred embodiments of the invention. In the exemplary embodiments, the described components of the embodiments each represent individual variants of the invention which are to be considered independently of one another, which also develop the invention independently of one another and are thus also to be regarded as part of the invention individually or in a combination other than that shown. Furthermore, the components described can also be combined with the variants of the invention described above.

### BRIEF DESCRIPTION OF THE FIGURES

FIG. 1 is a diagrammatic view of an exemplary embodiment of an apparatus according to the invention of a railway system with its interactions between functional components used;

FIG. 2 shows an exemplary embodiment of a computing environment for the apparatus according to FIG. 1 as a block diagram of the individual functional components and interfaces formed between them, individual computing instances executing program modules which can each run in one or more of the exemplary computers shown and it being possible for the interfaces shown to be implemented accordingly in terms of software in one computer or in terms of hardware between different computers;

FIG. 3 and FIG. 4 are illustrations showing examples of a prepared section of track images of a section of track (for example on a platform); and

FIG. 5 is a flow chart of an exemplary embodiment of a method according to the invention, it being possible for the method steps shown to be implemented individually or in groups by program modules and the computing instances and interfaces according to FIG. 2 being indicated by way of example.

### DETAILED DESCRIPTION OF THE INVENTION

Independent of the grammatical term usage, individuals with male, female or other gender identities are included within the term.

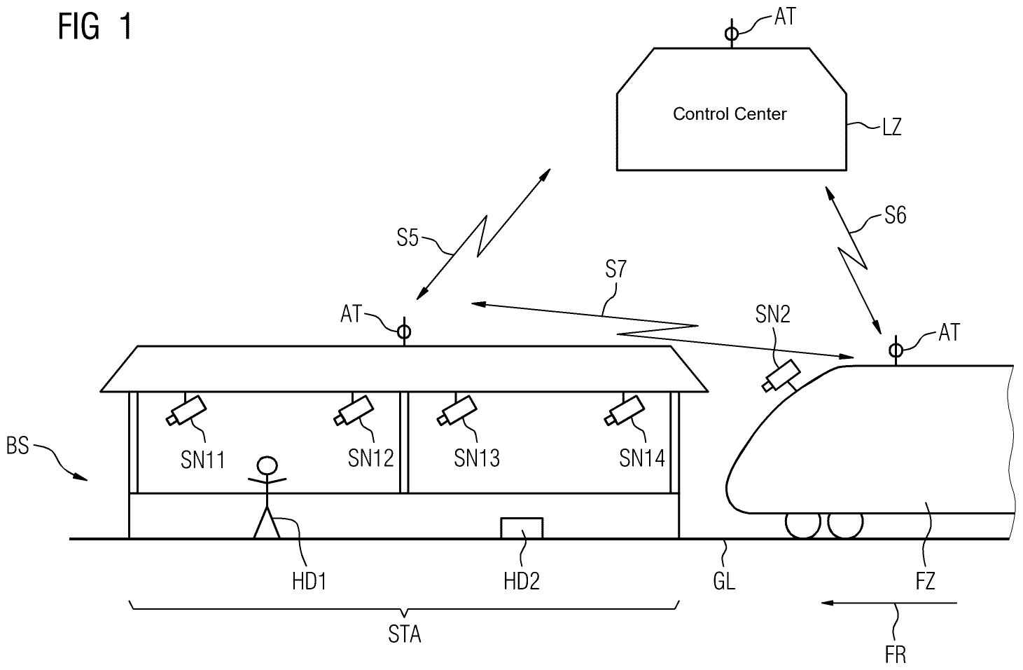

Referring now to the figures of the drawings in detail and first, particularly to FIG. 1 thereof, there is shown a platform BS and a track GL on which a vehicle FZ enters the platform BS. Furthermore, there is a control center LZ in which, for example, a current actual timetable can be monitored. Communication between the control center LZ, the vehicle FZ and the platform BS is possible by means of antennae AT via a fifth interface S5, a sixth interface S6 and a seventh interface S7.

The platform BS is equipped with four first sensors SN11, SN12, SN13, SN14, which in the example according to FIG. 1 are surveillance cameras. These monitor a section of track STA of the track GL, which is located in front of the platform BS. If an animate obstacle HD1, in the form of a person, or an inanimate obstacle HD2, in the form of an object, is located on the track GL, this is detected by the sensors.

At the same time, a second sensor SN2 is provided on the vehicle FZ, which is aligned with the image axis on the track GL in the direction of travel FR and can therefore also detect the animate obstacle and the inanimate obstacle HD2 respectively depending on the distance. With regard to obstacle detection, there is therefore a redundancy of the imaging detection systems on the vehicle FZ and on the platform BS.

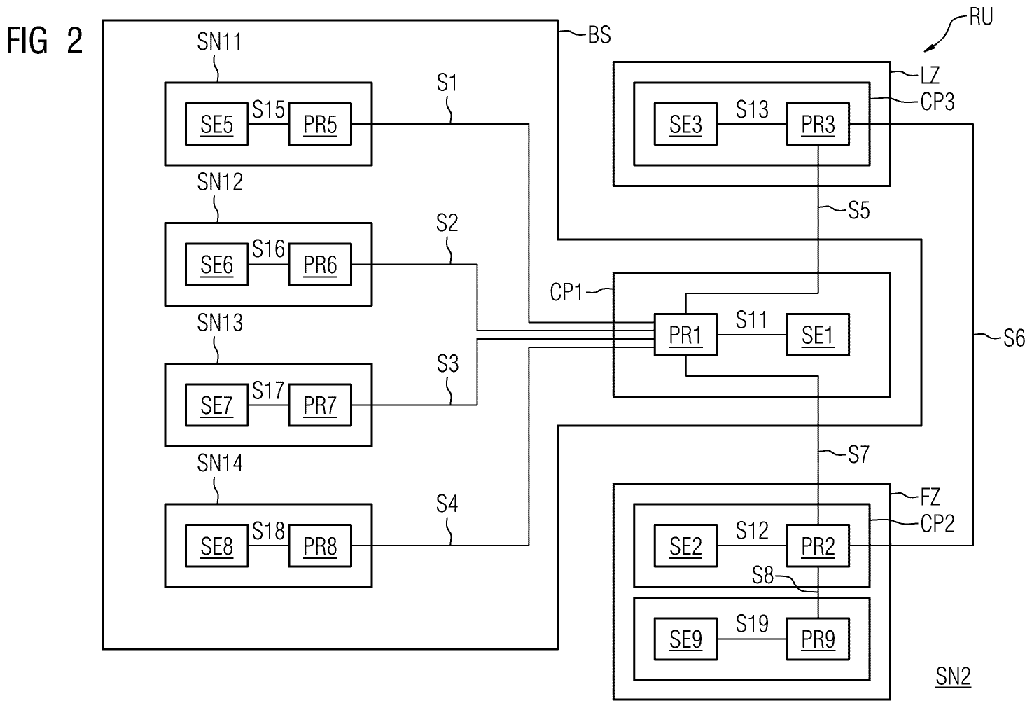

A computing environment RU in which the method according to the invention is executed can be seen from a joint consideration of FIG. 1 and FIG. 2. The computing instances and functional components used interact with each other via interfaces. It can be seen that on the platform BS a first computer CP1 (cf. FIG. 2) communicates with the first sensors SN11, SN12, SN13, SN14. A third computer CP3 is used in the control center LZ and a second computer CP2 is provided in the vehicle FZ, which communicates with the second sensor SN2 via an eighth interface S8. Of course, the computing environments RU formed by the control center LZ, the platform BS and the vehicle FZ may also contain a plurality of computers, of which those shown in FIG. 2 only serve as examples to represent the communication links.

FIG. 2 shows the computers and sensors forming the computing instances in more detail. In the first computer CP1, a first processor PR1 is connected to a first storage unit SE1 via an eleventh interface S11. In the second computer CP2, a second processor PR2 is connected to a second storage unit SE2 via a twelfth interface S12. In the third computer CP3, a third processor PR3 is connected to a third storage unit SE3 via a 13th interface S13. In the sensor S11, a fifth processor PR5 is connected to a fifth storage unit SE5 via a 15th interface S15. In the sensor S12, a sixth processor PR6 is connected to a sixth storage unit SE6 via a 16th interface S16. In the sensor S13, a seventh processor PR7 is connected to a seventh storage unit SE7 via a 17th interface S17. In the sensor S14, an eighth processor PR8 is connected to an eighth storage unit SE8 via an 18th interface S18. In the second sensor SN2, a ninth processor PR9 is connected to a ninth storage unit SE9 via a 19th interface S19.

The following can be seen from a combination of FIG. 1 and FIG. 2. The fifth processor PR5 of the first sensor SN11, SN12, SN13, SN14 and the first processor PR1 of the first computer CP1 are connected to each other via a first interface S1. The sixth processor PR6 of the second sensor SN2 and the first processor PR1 of the first computer CP1 are connected to each other via a second interface S2. The seventh processor PR7 of the third sensor and the first processor PR1 of the first computer CP1 are connected to each other via a third interface S3. The eighth processor PR8 of the fourth sensor and the first processor PR1 of the first computer CP1 are connected to each other via a fourth interface S4. The first processor PR1 and the second processor PR2 are connected to each other via the fifth interface S5. The second processor PR2 and the third processor PR3 are connected to each other via the sixth interface S6. The first processor PR1 and the second processor PR2 are connected to each other via the seventh interface S7.

In the context of this description of the invention, if reference is made only to computers, processors, storage units, sensors or interfaces, the information generally refers to all of the computers, processors, storage units and other functional components named in detail above which contribute to the formation of the computing environment RU when connected via the interfaces.

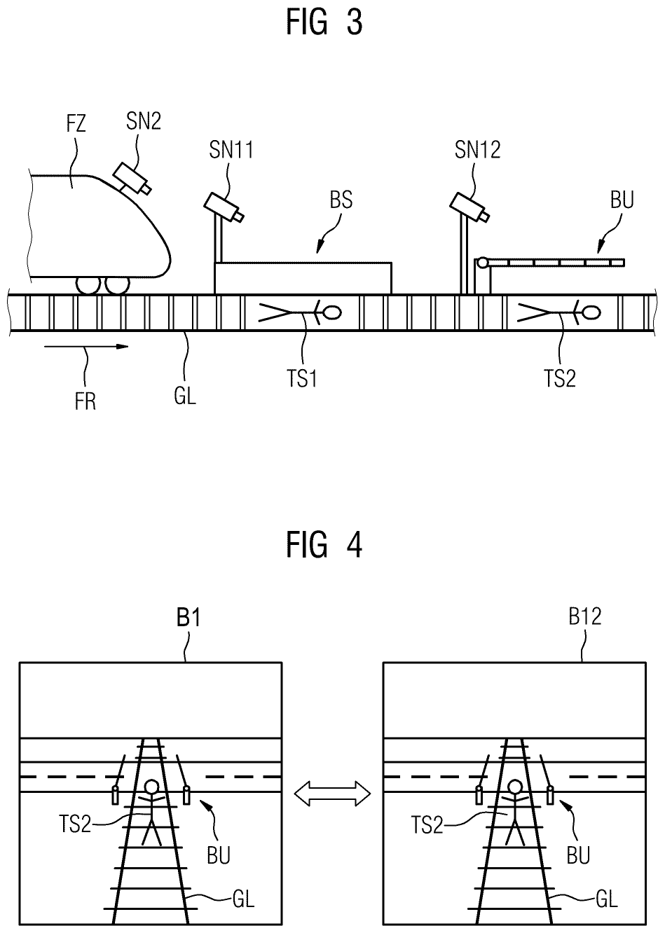

FIG. 3 once again shows a vehicle FZ on the track GL and a platform BS and in addition, a level crossing BU on the track GL. First sensors SN11, SN12 and a second sensor SN2 are also used. The track GL is shown folded into the drawing plane in the representation according to FIG. 3 in order to show that a first test structure TS1 and a second test structure TS2 are arranged parallel to the substrate. These are distorted representations of an animate obstacle, as indicated in FIG. 1. In reality, however, the test structure is an extremely flat arrangement in the track bed so that the vehicle FZ can drive over these test structures without a collision.

FIG. 4 shows how the second test structure TS2 appears in images recorded by the first sensors SN11, SN12 and the second sensors SN2. It is clear that an optical illusion creates the impression that there is an animate obstacle on the track GL. A first image B1 and a second image B12 are shown, the first image B1 being recorded by one of the first sensors SN11, SN12, SN13, SN14 and the second image B12 being recorded by one of the second sensors SN2.

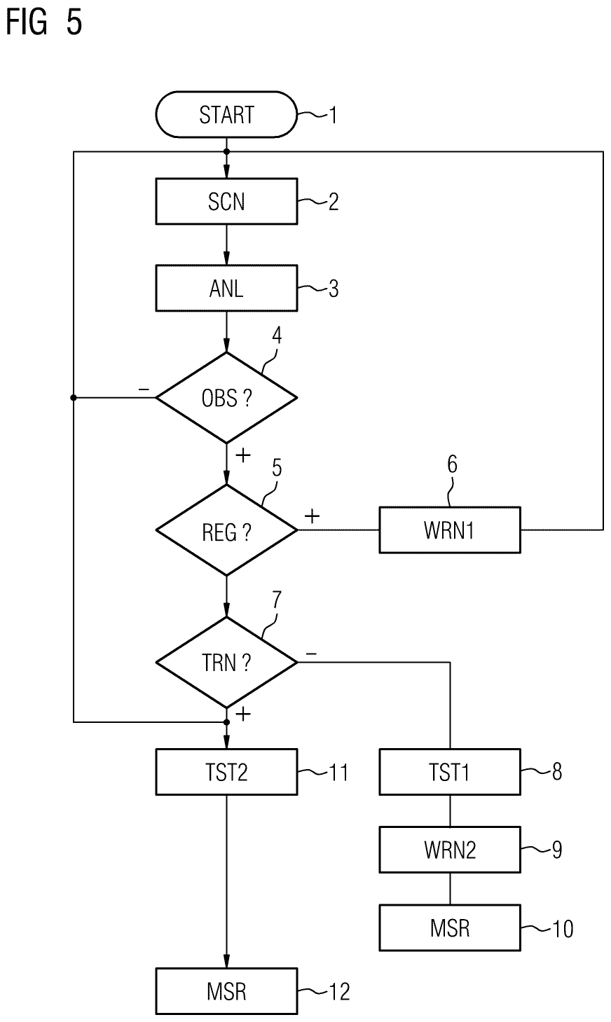

In addition to the test procedure, which is described in more detail hereinafter with regard to FIG. 5, the first sensors SN11, SN12 and the second sensor SN2 can thus also be used to generate redundancy when checking the test structure. The double arrow according to FIG. 4 is intended to indicate that image matching in the sense of redundant obstacle detection can also be performed during the test procedure if the second test structure TS2 was recorded by both one of the first sensors SN11, SN12 and one of the second sensors SN2.

Hereinafter, the method according to the invention is to be explained step by step in an exemplary manner, as shown in the flow chart according to FIG. 5.

In a first step 1, the method is started (START for short).

In a second step 2, the section of track STA is detected with the aid of the first sensors SN12 and/or second sensors SN2 (SCN for short). This produces images on which any obstacles can be detected (cf. FIG. 1).

In a third step 3, the images generated by the sensors (ANL for short) are analyzed in order to detect obstacles on the section of track STA. Obstacle detection itself takes place in a manner known per se using suitable analytical methods for computer-generated images. For the purpose of obstacle detection, the images undergo image processing in a manner known per se with the aid of a computer and the image contents are analyzed with a view to the presence of obstacles (use of known algorithms for image processing).

In a fourth step 4, a query is made as to whether an obstacle has been detected on the section of track STA (OBS for short). If this is not the case, a recursion takes place and step 2 is repeated. However, if this is the case, the process then continues with step 5.

In a fifth step 5, a further query is made as to whether the detected obstacle was detected during regular operation (REG? for short). If this is the case, the process continues with step 6. However, if this is not the case, the process continues with step 7, in this case a training procedure being started for the imaging sensors.

In a sixth step 6, a first signal to warn of obstacles is generated and output or further processed in a computer-aided process (WRN1 for short). The signal leads to an interruption of rail traffic because there is an immediate risk of collision. For example, the warning signal could also be issued in the driver's cab for the driver of an incoming train so that the driver is ready to brake.

In a seventh step 7, a further query is made as to whether the detected obstacle is a train (TRN? for short). A train is usually not to be interpreted as an obstacle because it is part of normal rail operation for trains to pull up at a platform BS. In this case, the process continues with step 11.

In an eleventh step 11, a second test routine (TST2 for short) is executed. This test routine serves as a failure disclosure for the first sensors SN11, SN12, SN13, SN14 and thus advantageously increases the safety level during the course of the method. In this manner, errors in the course of the method can be detected at an early stage and lead, for example, to the introduction of maintenance measures according to step 12 (MSR for short).

To ensure that the train is allowed to pull up at the platform BS as scheduled, a comparison with a timetable not shown in FIG. 5, in particular a current actual timetable, can be carried out, for example, in the control center LZ via the first interface S1. If the train is not expected to arrive at the platform BS as scheduled, an obstacle signal can be generated because the unscheduled train could represent an obstacle for a scheduled train.

If no train could be detected, this means that another obstacle is involved. However, there is no acute risk of collision with the obstacle as it is a test structure. In this case, the process continues with a first test routine (TST1 for short) according to step 8. This test routine serves as a failure disclosure for the second sensors SN2 and thus advantageously increases the safety level during the course of the method. In a ninth step 9, a second signal is generated as a warning which can be output or processed with the aid of a computer (WRN2 for short).

In a tenth step 10, a safety measure (MSR for short) is implemented. A suitable measure must be deduced, for example manual monitoring of the section of track STA by railway employees. Nevertheless, a recursion to step 2 can take place if the error has only occurred temporarily and subsequent recursion loops again result in the proper functioning of automatic monitoring for obstacles.

The following is a summary list of reference numerals and the corresponding structure used in the above description of the invention:
AT Antennae
B1 First image
B12 Second image
BS Platform
BU Level crossing
CP1 First computer
CP2 Second computer
CP3 Third computer
FR Direction of travel
FZ Vehicle
GL Track
HD1 Animate obstacle
HD2 Inanimate obstacle
LZ Control center
PR1 First processor
PR2 Second processor
PR3 Third processor
PR5 Fifth processor
PR6 Sixth processor
PR7 Seventh processor
PR8 Eighth processor
PR9 Ninth processor
RU Computing environment
S1 First interface
S11 Eleventh interface
S12 Twelfth interface
S13 13th interface
S15 15th interface
S16 16th interface
S17 17th interface
S18 18th interface
S19 19th interface
S2 Second interface
S3 Third interface
S4 Fourth interface
S5 Fifth interface
S6 Sixth interface
S7 Seventh interface
S8 Eighth interface
SE1 First storage unit
SE2 Second storage unit
SE3 Third storage unit
SE5 Fifth storage unit
SE6 Sixth storage unit
SE7 Seventh storage unit
SE8 Eighth storage unit
SE9 Ninth storage unit
SN11, SN12,
SN13, SN14 First sensor
SN2 Second sensor
STA Track section
TS1 First test structure
TS2 Second test structure

1. A method for monitoring a section of track for obstacles, which comprises the steps of:
a) recording the section of track using sensors including at least one first imaging sensor and at least one second imaging sensor for monitoring, the at least one first imaging sensor being operated on a vehicle, and the at least one second imaging sensor being operated in a fixed position on the section of track, wherein during operation the sensors are aligned with the section of track in such a manner that each location of the section of track is present in a respective first image of the at least one first imaging sensor and a respective second image of the at least one second imaging sensor;
b) analyzing first images and second images with an aid of a computer for the obstacles in the section of track;
c) generating a signal indicating a presence of an obstacle if the obstacle has been detected by means of an analysis both in at least one of the first images and also in at least one of the second images; and
d) generating a first signal indicating an error if the obstacle was detected by means of the analysis only in at least one of the first images or only in at least one of the second images.

2. The method according to claim 1, wherein the at least one second imaging sensor is one of a plurality of second sensors, each of the second sensors belongs to a second group of the second sensors disposed at a distance from each other on the section of track, wherein generated images of the second group are each adjacent to one another in a border area with adjacent images.

3. The method according to claim 1, which further comprises checking a functioning of the monitoring the section of track by the at least one first imaging sensor by the further steps of:
e) disposing a first test structure in the section of track as an obstacle which can be driven over by the vehicle without collision and a position of the obstacle in the section of track is available to the method as a position data set;
f) analyzing the first images with the aid of the computer for the obstacles in the section of track; and
g) outputting a second signal indicating an error if no said obstacle is detected by means of an analysis at the position identified by the position data set.

4. The method according to claim 3, wherein the signal indicating the presence of the obstacle is a test signal.

5. The method according to claim 3, wherein the first test structure is a two-dimensional representation of the obstacle on a screen, wherein:
h) the screen is aligned parallel or at an angle of no more than 30° to a substrate of the section of track; and
i) the obstacle is shown distorted on the screen, wherein the obstacle appears undistorted in relation to an image axis for the at least one first imaging sensor.

6. The method according to claim 3, which further comprises checking a functioning of the monitoring the section of track using the at least one second imaging sensor if the vehicle is present on the section of track, by:
j) making a current position of the vehicle available in the position data set;
k) analyzing the second images with the aid of the computer for the obstacles in the section of track; and
l) outputting a third signal indicating an error if no said obstacle is detected by means of an analysis at the current position identified by the position data set.

7. The method according to claim 6, which further comprises requesting manual monitoring of the section of track for the obstacles by railway personnel as soon as the first signal or the second signal or the third signal has been evaluated.

8. The method according to claim 5, which further comprises setting the angle to be no more than 10°.

9. A railway system, comprising:
a section of track;
a plurality of imaging sensors for monitoring said section of track installed in the railway system; and
a computing environment set up to carry out the method according to claim 1.

10. A non-transitory computer program product containing computer executable instructions which when executed by a computer perform a method for monitoring a section of track for obstacles, which comprises the steps of:
analyzing first images and second images with an aid of the computer for detecting the obstacles in the section of track;
generating a signal indicating a presence of an obstacle if the obstacle has been detected by means of an analysis both in at least one of the first images and also in at least one of the second images; and
generating a first signal indicating an error if the obstacle was detected by means of the analysis only in at least one of the first images or only in at least one of the second images.

11. A non-transitory computer-readable storage medium containing data stored as data sets in such a manner that the data sets make it possible to execute the non-transitory computer program product according to claim 10.
